(19) United States
(12) Patent Application Publication
(10) Pub. No.: US 2023/0052724 A1
(43) Pub. Date: Feb. 16, 2023

(54) WIRELESS COMMUNICATION APPARATUS AND METHOD

(71) Applicant: SONY GROUP CORPORATION, TOKYO (JP)

(72) Inventor: REN SUGAI, TOKYO (JP)

(21) Appl. No.: 17/785,686

(22) PCT Filed: Dec. 11, 2020
(86) PCT No.: PCT/JP2020/046264

§ 371 Date: Jun. 15, 2022

(30) Foreign Application Priority Data
Dec. 25, 2019 (JP) 2019-234488

(51) Int. Cl. H04W 72/12

(52) U.S. Cl. CPC H04W 72/1263; H04W 84/12

(57) ABSTRACT

The present technology relates to a wireless communication apparatus and a wireless communication method that make it possible to achieve an improvement in the number of multiplexing on a non-orthogonal axis.

The wireless communication apparatus transmits a signal including information for setting of an occupancy period of a wireless transmission path on a basis of extraction processing time required for processing, which includes interference cancellation processing in communication using non-orthogonal multiplexing, to extract desired data from a received signal. The present technology is applicable to a wireless communication system.

### TECHNICAL FIELD

The present technology relates to a wireless communication apparatus and a wireless communication method, and in particular to a wireless communication apparatus and a wireless communication method that make it possible to achieve an improvement in the number of multiplexing on a non-orthogonal axis.

### BACKGROUND ART

It is anticipated that an increase in the number of terminals allows a WLAN (Wireless LAN) communication environment to be denser. Therefore, it is necessary to multiplex a large number of terminals with one communication opportunity.

In an IEEE 802.11ax standard, uplink multi-user (UpLink Multi User: UL MU) communication using multiplexing on a frequency axis and a spatial stream axis has been introduced, in addition to an existing downlink multi-user (DownLink Multi User: DL MU) communication. In the future, it is anticipated that multiple access using the non-orthogonal multiplexing (user multiplexing using the non-orthogonal multiplexing, Non-Orthogonal Multiple Access: NOMA (hereinafter, referred to as the non-orthogonal multiplexing or NOMA)) is introduced as a technique for further improvement in frequency utilization efficiency. The non-orthogonal multiplexing is a technique to improve the frequency utilization efficiency by superimposing signals of a plurality of users on the same frequency at the same time for transmission.

The non-orthogonal multiplexing generally requires interference cancellation processing as one processing of pieces of extraction processing to extract desired data from signals received on reception side. Meanwhile, in the WLAN, it is assumed that a reception result is returned after an elapse of a short period of time of SIFS (Short Inter Frame Space) interval after reception of the signal. Therefore, this results in limitation on time available for the interference cancellation processing as well as limitation on the number of multiplexing on the non-orthogonal axis.

Meanwhile, in a physical layer of the IEEE802.11ax standard, Packet Extension is defined as a margin for decoding delay. PTL 1 proposes a technique related to this Packet Extension.

### CITATION LIST

### Patent Literature

PTL 1: International Publication No. WO2016/143970 1

### SUMMARY OF THE INVENTION

### Problem to Be Solved by the Invention

In Packet Extension, however, no consideration is given to processing time caused by interference cancellation processing in a case where non-orthogonal multiplexing is introduced. The processing time is supposed to be very large delay as compared with decoding delay which is taken into consideration in Pack Extension. Therefore, as described above, time available for the interference cancellation processing is limited, resulting in limitation on the number of multiplexing on a non-orthogonal axis.

In addition, examples of another method include returning a reception result at another transmission opportunity. However, in a case where no transmission opportunity for returning the reception result is obtained, it may occur that a sender acquires the transmission opportunity before the return. As a result, an apparatus of the sender determines that no correct reception has been made, and results in executing retransmission that is originally unnecessary.

The present technology has been made in view of such circumstances, and is directed to enabling achievement of an improvement in the number of multiplexing on a non-orthogonal axis.

### Means for Solving the Problem

A wireless communication apparatus according to an aspect of the present technology includes a transmission unit that transmits a signal including information for setting of an occupancy period of a wireless transmission path on the basis of extraction processing time required for processing, which includes interference cancellation processing in communication using non-orthogonal multiplexing, to extract desired data from a received signal.

A wireless communication apparatus according to another aspect of the present technology includes a communication control unit that transmits, on a basis of information concerning a return timing of a received reception result, the reception result of data extracted from a received signal.

In the aspect of the present technology, a signal including information for setting of an occupancy period of a wireless transmission path is transmitted on the basis of extraction processing time required for processing, which includes interference cancellation processing in communication using non-orthogonal multiplexing, to extract desired data from a received signal.

In the other aspect of the present technology, on a basis of information concerning a return timing of a received reception result, the reception result of data extracted from a received signal is transmitted.

### BRIEF DESCRIPTION OF THE DRAWINGS

FIG. 1 illustrates a configuration example of a wireless communication system of the present technology.

FIG. 2 is a block diagram illustrating a configuration example of the wireless communication apparatus.

FIG. 3 illustrates an example of a sequence of a first embodiment of the present technology.

FIG. 4 is a flowchart describing selection processing of an operation at time t5 in FIG. 3.

FIG. 5 illustrates another example of the sequence of the first embodiment of the present technology.

FIG. 6 illustrates still another example of the sequence of the first embodiment of the present technology.

FIG. 7 illustrates an example of a frame configuration of ACK Extension.

FIG. 8 illustrates an example of a sequence of a second embodiment of the present technology.

FIG. 9 illustrates an example of a frame configuration of a Trigger frame.

FIG. 10 illustrates a modification example of the sequencing of the second embodiment of the present technology.

FIG. 11 illustrates another example of the sequence of the second embodiment of the present technology.

FIG. 12 illustrates a modification example of the sequence of the second embodiment of the present technology.

FIG. 13 illustrates an example of signaling of a third embodiment of the present technology.

FIG. 14 illustrates an example of a frame configuration of Capability information.

FIG. 15 illustrates an example of a sequence of a third embodiment of the present technology.

FIG. 16 illustrates an example of a frame configuration of NOMA PPDU in the case of FIG. 15.

FIG. 17 illustrates another example of the sequence of the third embodiment of the present technology.

FIG. 18 illustrates an example of the frame configuration of the NOMA PPDU in the case of FIG. 17.

FIG. 19 illustrates an example of a sequence of a fourth embodiment of the present technology.

FIG. 20 illustrates an example of a frame configuration of ACK Trigger.

FIG. 21 illustrates another example of the frame configuration of the ACK Trigger.

FIG. 22 is a block diagram illustrating a configuration example of a computer.

### MODES FOR CARRYING OUT THE INVENTION

Hereinafter, description is given of modes for carrying out the present technology. The description is given in the following order.
1. System Configuration
2. First Embodiment (UL MU Communication Using Non-Orthogonal Multiplexing)
3. Second Embodiment (Modification Example of UL MU Communication Using Non-Orthogonal Multiplexing)
4. Third Embodiment (DL MU Communication Using Non-Orthogonal Multiplexing)
5. Fourth Embodiment (Modification Example of D1 MU Communication Using Non-Orthogonal Multiplexing)
6. Others

### 1. System Configuration

### Configuration Example of Wireless Communication System

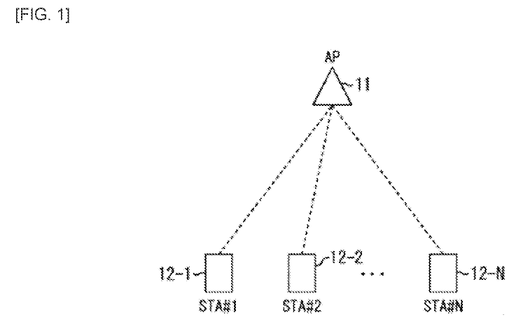

FIG. 1 illustrates a configuration example of a wireless communication system of the present technology.

The wireless communication system in FIG. 1 is configured by coupling a base station (AP) to a plurality of terminals (STA) #1 to #N by means of wireless communication.

The base station (AP) is configured by a wireless communication apparatus 11. The terminals (STA) #1 to #N are configured by wireless communication terminals 12-1 to 12-N. Hereinafter, the base station (AP) is simply referred to as AP, and the terminals (STA) #1 to #N are simply referred to as STAs #1 to #N. It is to be noted that, in a case where there is no need to distinguish the STAs #1 to #N and the wireless communication terminals 12-1 to 12-N, they are referred to as STA and a wireless communication terminal 12, respectively.

In a case where UL MU communication using non-orthogonal multiplexing is performed, the AP transmits, to a subordinate STA, a trigger frame requesting the UL MU communication using the non-orthogonal multiplexing. The STA that conducts the UL MU communication using the non-orthogonal multiplexing is designated by this trigger frame. The STA designated for the UL MU communication using the non-orthogonal multiplexing transmits a signal using the non-orthogonal multiplexing on the basis of the received trigger frame. The AP returns, to the STA having conducted the UL MU communication, a reception result of the signal received from the STA after an elapse of an SIFS interval.

Meanwhile, in a case where DL MU communication is performed, the AP transmits a signal to a subordinate STA using the non-orthogonal multiplexing. The STA, which serves as a destination of the signal, returns a reception result after an elapse of the SIFS interval in the reception of the signal.

In both cases, NOMA typically requires interference cancellation processing of a received signal on reception side.

Therefore, in both cases of the UL MU communication and the DL MU communication, the AP transmits a signal including information for setting of an occupancy period of a wireless transmission path on the basis of extraction processing time required for processing, which includes interference cancellation processing in communication using the non-orthogonal multiplexing, to extract desired data from the received signal. It is to be noted that the occupancy period is hereinafter referred to also as an occupancy period of the present technology.

### Configuration Example of Apparatus

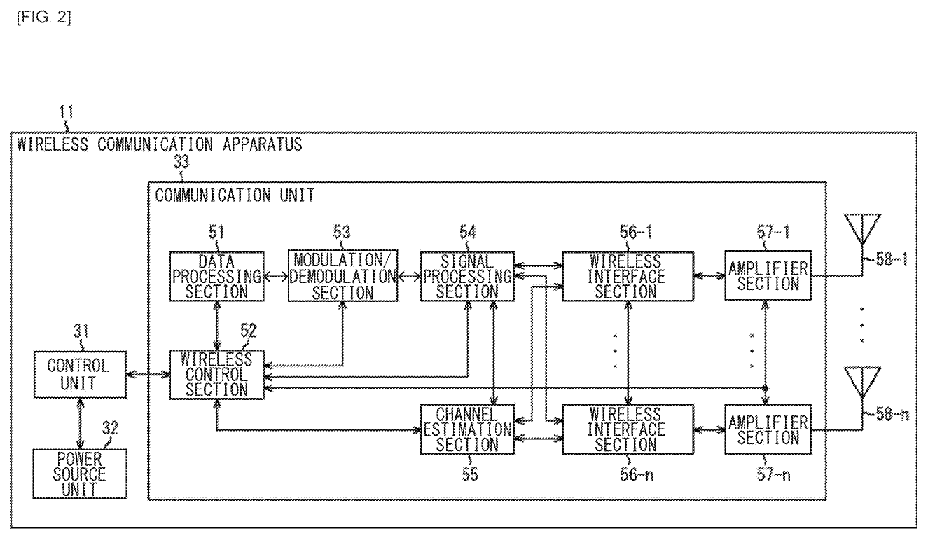

FIG. 2 is a block diagram illustrating a configuration example of a wireless communication apparatus 11.

The wireless communication apparatus 11 illustrated in FIG. 2 is an apparatus that operates as an AP.

The wireless communication apparatus 11 includes a control unit 31, a power source unit 32, and a communication unit 33. The communication unit 33 may be implemented by an LSI.

The communication unit 33 performs data transmission/reception. The communication unit 33 includes a data processing section 51, a wireless control section 52, a modulation/demodulation section 53, a signal processing section 54, a channel estimation section 55, wireless interface (I/F) sections 56-1 to 56-N, amplifier sections 57-1 to 57-N, and antennas 58-1 to 58-N.

It is to be noted that, of the wireless interface sections 56-1 to 56-N, the amplifier sections 57-1 to 57-N, and the antennas 58-1 to 58-N, sections having the same branch number may be defined as one set, and the one set may be one component. In addition, functions of the amplifier sections 57-1 to 57-N may be included in the wireless interface sections 56-1 to 56-N.

It is to be noted that, hereinafter, the wireless interface sections 56-1 to 56-N, the amplifier sections 57-1 to 57-N, and the antennas 58-1 to 58-N are simply referred to, as appropriate, as a wireless interface section 56, an amplifier section 57, and an antenna 58, respectively, in a case where there is no need to distinguish them.

The control unit 31 is configured by a CPU (Central Processing Unit), a ROM (Read Only Memory), a RAM (Random Access Memory), and the like. The control unit 31 executes a program stored in the ROM or the like to control the power source unit 32 and the wireless control section 52 of the communication unit 33.

The power source unit 32 is configured by a battery power source or a fixed power source, and supplies power to the entire wireless communication apparatus 11.

Upon transmission, the data processing section 51 generates a packet for wireless transmission using data supplied from a higher-level layer such as an application layer. The data processing section 51 performs processing such as addition of a header for medium access control (MAC: Media Access Control) and addition of an error-detecting code on the generated packet, and outputs processed data to the modulation/demodulation section 53.

Upon reception, the data processing section 51 performs analysis of a MAC header, detection of a packet error, reorder processing, and the like on data supplied from the modulation/demodulation section 53, and outputs processed data to a higher-level layer of itself.

The wireless control section 52 transfers and receives information or data to and from each unit of the wireless communication apparatus 11, and controls each section inside the communication unit 33.

Upon transmission, the wireless control section 52 performs, as necessary, parameter setting in the modulation/demodulation section 53 and the signal processing section 54, scheduling of packets in the data processing section 51, and parameter setting or transmission power control in the wireless interface section 56 and the amplifier section 57. Upon reception, the wireless control section 52 performs, as necessary, parameter setting of the modulation/demodulation section 53, the signal processing section 54, the wireless interface section 56, and the amplifier section 57.

In addition, in particular, the wireless control section 52 controls transmission of a signal including information for setting of the occupancy period of the wireless transmission path on the basis of the extraction processing time.

Further, the wireless control section 52 controls the return of a reception result to the UL MU communication using the non-orthogonal multiplexing. The wireless control section 52 controls transmission in the DL MU communication using the non-orthogonal multiplexing, and controls reception of a reception result of the DL MU communication using the non-orthogonal multiplexing.

It is to be noted that at least a portion of these operations of the wireless control section 52 may be performed by the control unit 31 instead of the wireless control section 52. In addition, the control unit 31 and the wireless control section 52 may be configured as one block.

Upon transmission, the modulation/demodulation section 53 performs encoding, interleaving, and modulation on data supplied from the data processing section 51 on the basis of an encoding scheme and a modulation scheme set by the control unit 31 to generate a data symbol stream. The modulation/demodulation section 53 outputs the generated data symbol stream to the signal processing section 54.

Upon reception, the modulation/demodulation section 53 outputs, to the data processing section 51 or the wireless control section 52, data resulting from demodulation, deinterleaving, and decoding performed on the data symbol stream supplied from the signal processing section 54.

Upon transmission, the signal processing section 54 performs signal processing used for spatial separation on the data symbol stream supplied from the modulation/demodulation section 53, as necessary, and outputs one or more transmitted symbol streams resulting from the signal processing to each wireless interface section 56.

Upon reception, the signal processing section 54 performs signal processing on the received symbol stream supplied from each wireless interface section 56, performs spatial separation of the stream as necessary, and outputs the resulting data symbol stream from the spatial separation to the modulation/demodulation section 53. In addition, the signal processing section 54 applies interference cancellation processing to the data symbol stream to extract a desired signal from superimposed signals. At this time, the interference cancellation processing is performed in conjunction with the modulation/demodulation section 53 and the data processing section 51. The interference cancellation processing uses complex channel gain information calculated by the channel estimation section 55.

The channel estimation section 55 calculates the complex channel gain information on a propagation path from a preamble portion such as a Legacy preamble and a training signal portion such as STF (short Training Field) and LTF (Long Training Field) of the received symbol stream supplied from each wireless interface section 56. The complex channel gain information is supplied to the modulation/demodulation section 53 and the signal processing section 54 via the wireless control section 52, and is used for demodulation processing at the modulation/demodulation section 53 and spatial separation processing at the signal processing section 54.

Upon transmission, the wireless interface section 56 converts the transmitted symbol stream from the signal processing section 54 into an analog signal to perform filtering, up-conversion to a carrier frequency, and phase control. The wireless interface section 56 outputs an analog signal after the phase control to the amplifier section 57.

Upon reception, the wireless interface section 56 performs phase control, down-conversion, and inverse filtering on the analog signal supplied from the amplifier section 57 to convert it into a digital signal. The wireless interface section 56 outputs a received symbol stream, which is a converted digital signal, to the signal processing section 54 and the channel estimation section 55.

Upon transmission, the amplifier section 57 amplifies the analog signal supplied from the wireless interface section 56 to predetermined power, and outputs the analog signal of which power is amplified to the antenna 58. Upon reception, the amplifier section 57 amplifies the analog signal supplied from the antenna 58 to predetermined power, and outputs the analog signal of which power is amplified to the wireless interface section 56.

At least a portion of at least one of a transmitting function or a receiving function of the amplifier section 57 may be included in the wireless interface section 56. In addition, at least a portion of at least one function of the amplifier section 57 may be performed by an external component of the communication unit 33.

It is to be noted that the configuration of the wireless communication terminal 12 operating as the STA is basically similar to that of the wireless communication apparatus 11, and thus the configuration of the wireless communication apparatus 11 is used in the following description of the wireless communication terminal 12.

In this case, during the UL MU communication, the wireless control section 52 controls reception of a reception result of the UL MU communication by the non-orthogonal multiplexing on the basis of a signal including information for setting of an occupancy period of a wireless transmission path transmitted from the AP.

Meanwhile, during the DL MU communication, the wireless control section 52 controls return of a reception result of the DL MU communication by the non-orthogonal multiplexing on the basis of a signal including information for setting of the occupancy period of the wireless transmission path transmitted from the AP.

### 2. First Embodiment (UL MU Communication Using Non-Orthogonal Multiplexing)

First, description is given, as a first embodiment of the present technology, of a case of performing the UL MU communication using the non-orthogonal multiplexing.

### Example of a Case where AP is Able to Return Not All Reception Results of UL MU Communication at SIFS Interval

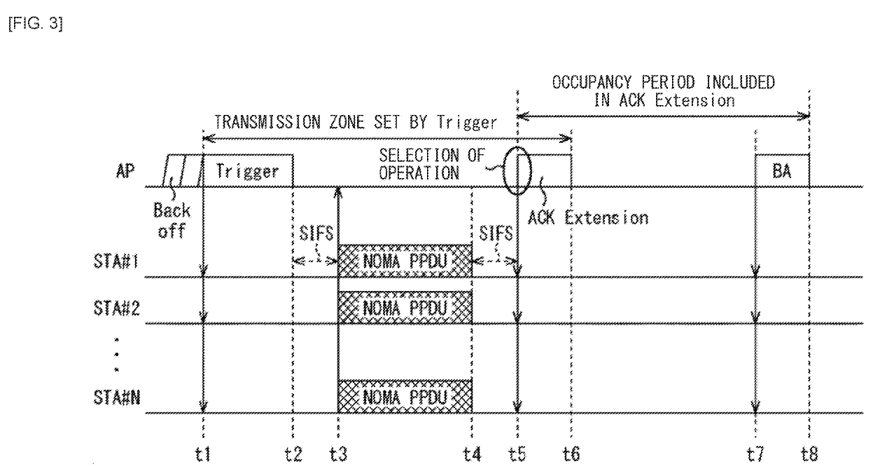

FIG. 3 illustrates an example of a sequence in a case where not all reception results of the UL MU communication are able to be returned at the SIFS interval in the first embodiment of the present technology. This is an operation for solving the problem to be solved by the invention in the present technology.

FIG. 3 illustrates a sequence in which the AP conducts the UL MU communication using a plurality of STA#1 to STA#N and the non-orthogonal multiplexing. Options of types of the non-orthogonal axis include interleaving, scrambling, sparse spread encoding, linear operation to transmission signals, transmission power, sparse wireless resource allocation, and the like. A different multiplexing scheme, in addition to the non-orthogonal multiplexing, may be combined to perform the multiplexing.

In FIG. 3, the horizontal axis represents time. A lateral doubleheaded arrow (broken line) indicates an interval of a predetermined certain period of time (processing extension time) referred to as the SIFS interval. The same also applies to the subsequent drawings.

After Back off, at time t1 at which the AP has acquired a transmission opportunity, the AP requests subordinate STA#1 to STA#N to perform the UL MU communication using the non-orthogonal multiplexing by using a Trigger frame. In the Trigger frame, the AP sets required time for a series of data exchange sequence in the UL MU communication, for the Trigger frame transmission zone. The required time is the sum of time length of the Trigger frame, SIFS interval between the Trigger frame and NOMA PPDU (PLCP Protocol Data Unit) which is data, time length of the NOMA PPDU, SIFS interval between the NOMA PPDU and a reception result for the NOMA PPDU (Block ACK(BA)), and time length of the BA.

The STA#1 to STA#N having been requested to perform the UL MU communication transmit the NOMA PPDU in accordance with a parameter described in the Trigger frame at time t3 at which the SIFS interval has elapsed from time t2 at which the reception of the Trigger was completed.

The NOMA PPDU transmitted at this time has been multiplexed by a combination of the non-orthogonal multiplexing and orthogonal multiplexing at a frequency using a subchannel by OFDMA (Orthogonal Frequency Division Multiple Access) or spatial multiplexing by MIMO (Multi Input Multi Output). In addition, although the present embodiment has been described by assuming the non-orthogonal multiplexing, the present technology may be applied to MU-MIMO alone.

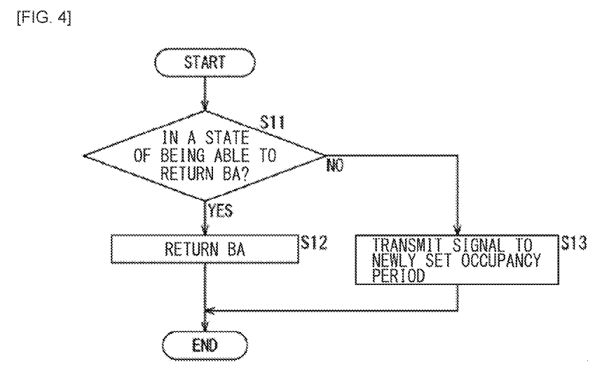

The AP performs extraction processing including the interference cancellation processing in order to separate the non-orthogonally multiplexed signals on the received signals, and extracts data of each STA. At time t5 at which the SIFS interval has elapsed from time t4 at which an end of the NOMA PPDU was received, the AP selects an operation depending on whether or not the BA is in a state of being able to be returned. It is to be noted that the selection processing of an operation at this time is described later with reference to FIG. 4.

At time t5, in a case where determination is made that the BA is not in a state of being able to be returned, the AP transmits, as a response to the NOMA PPDU, ACK Extension to the STA#1 to STA#N having executed the UL MU communication. The ACK Extension includes, as information for setting of the occupancy period, an occupancy period from time t5 to time t8. In addition, the ACK Extension includes information requesting continuation of waiting for a reception result.

It is to be noted that, a case where the AP determines that the BA is not in a state of being able to be returned occurs when the reception processing is not completed until the SIFS interval has elapsed. For example, in a case where the AP increases required time for the interference cancellation processing to secure the number of multiplexing of the UL MU communication, decoding performance is improved by repeating the interference cancellation processing to reduce the number of retransmission; it is assumed that, in such a case, the reception processing of the AP is not completed until the SIFS interval has elapsed.

Time t6 is time when the STA#1 to STA#N receive an end of the ACK Extension.

The STA#1 to STA#N, which have received the ACK Extension, determine that the BA is returned from the AP during the occupancy period included in the ACK Extension, and wait for the BA to be returned.

Thus, determination is made that the subordinate STA has failed in transmission because the BA has not been returned, thus making it possible to prevent retransmission of unnecessary data by SU (Single User) transmission. In addition, it is possible to prevent an STA not participating in the UL MU communication from interrupting in the middle of a series of communication sequence of the UL MU communication.

For example, the AP returns the BA at time t7 prior to time t8 at the end of the occupancy period included in the ACK Extension.

At time t8, the BA is received by the STA#1 to STA#N, thereby ending the series of data exchange sequence of the UL MU communication.

### Example of Selection Processing of Operation

FIG. 4 is a flowchart describing selection processing of an operation at time t5 in FIG. 3.

In step S11, the wireless control section 52 of the AP determines whether or not the BA is in a state of being able to be returned. When determination is made in step S11 that the wireless control section 52 is in a state of being able to return the BA, the processing proceeds to step S12.

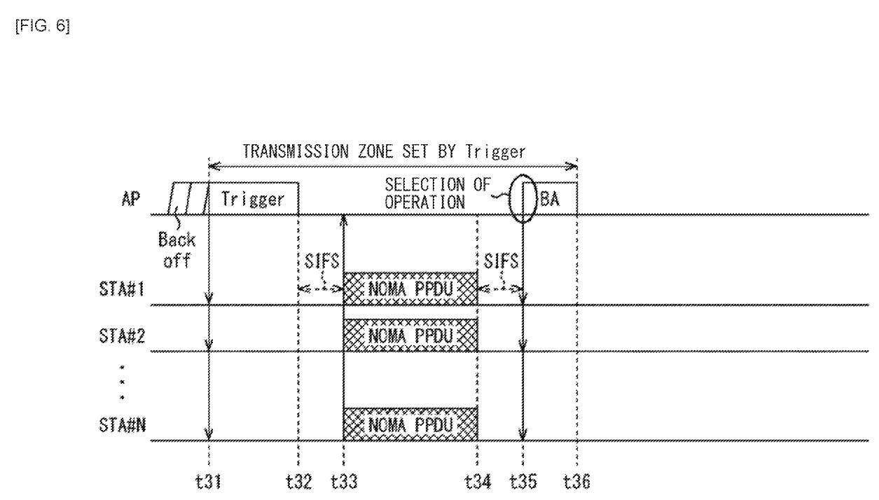

In step S12, the wireless control section 52 controls each section of the communication unit 33, and controls each section of the communication unit 33 to return the BA which is a signal storing the reception result, as described later with reference to FIG. 6.

In a case where determination is made in step S11 that the wireless control section 52 is not in a state of being able to return the BA, the processing proceeds to step S13.

In step S13, instead of controlling each section of the communication unit 33 to return the BA, the wireless control section 52 returns a signal (ACK Extension in FIG. 3) to newly set an occupancy period of the wireless transmission path as described above with reference to FIG. 3.

After step S12 or S13, the selection processing of an operation ends.

### Modification Example of Sequence in a Case where AP is Unable to Return Reception Result of UL MU Communication at SIFS Interval

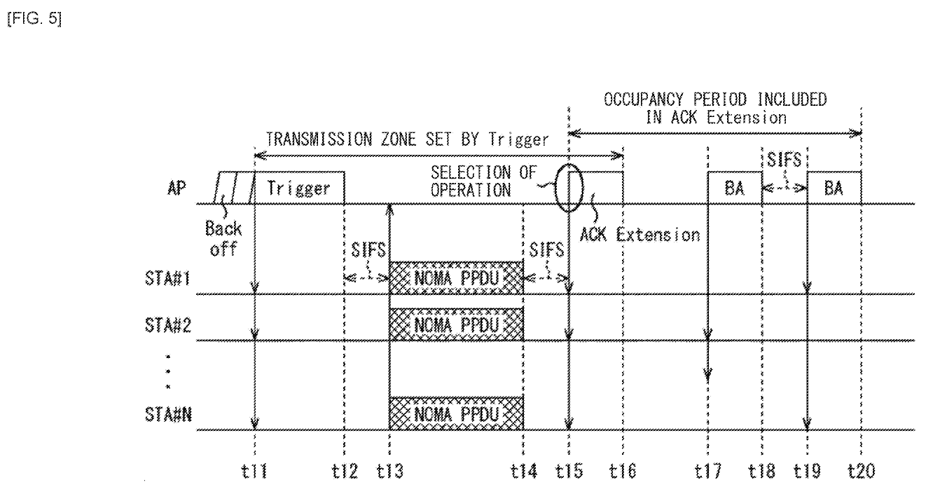

FIG. 5 illustrates a modification example of a sequence in a case where not all reception results of the UL MU communication are able to be returned at the SIFS interval in the first embodiment of the present technology.

FIG. 5 illustrates another modification example of the sequence in a case where the AP determines that the BA is not in a state of being able to be returned, in step S11 in FIG. 4. Pieces of processing of time t11 to time t14 in FIG. 5 are similar to the pieces of processing of time t1 to time t4 in FIG. 3, and thus descriptions thereof are omitted.

At time t15 at which the SIFS interval has elapsed from time t14 at which the end of the NOMA PPDU was received, the AP selects an operation depending on whether or not the BA is in a state of being able to be returned, as described above with reference to FIG. 4.

At time t15, in a case where determination is made that the BA is not in a state of being able to be returned, the AP transmits the ACK Extension to the STA#1 to STA#N having executed the UL MU communication. The ACK Extension includes an occupancy period from time t15 to time t20 as information for setting of an occupancy period. In addition, the ACK Extension includes information requesting continuation of waiting for the reception result.

At time t16, the end of the ACK Extension is received by the STA#1 to STA#N.

The STA#1 to STA#N having received the ACK Extension determine that the BA is returned from the AP during the occupancy period included in the ACK Extension, and wait for the BA to be returned.

For example, the AP returns the BA at one of a plurality of time t17, ... , time t19 during the occupancy period included in the ACK Extension. For example, in a case where the BA is returned at time t17, the AP returns the next BA at time t19 with the SIFS interval spaced apart from time t18 at which an end of the BA is returned.

At time t20, the BA, which has been returned last, is received by the STA#1 to STA#N, thereby ending the sequence of the UL MU communication.

### Example of Sequence in a Case where AP is Able to Return Reception Result of UL MU Communication at SIFS Interval

FIG. 6 illustrates an example of a sequence in a case where the reception results of the UL MU communication are able to be returned at the SIFS interval in the first embodiment of the present disclosure. In this case, an operation is similar to that of the data sequence of the existing UL MU communication.

FIG. 6 illustrates an example of a sequence in a case where determination is made in step S11 in FIG. 4 that the BA is not in a state of being able to be returned. Pieces of processing of time t31 to time t34 in FIG. 6 are similar to the pieces of processing of time t1 to time t4 in FIG. 3, and thus descriptions thereof are omitted.

At time t35 at which the SIFS interval has elapsed from time t34 at which the end of the NOMA PPDU was received, the AP selects an operation depending on whether or not the BA is in a state of being able to be returned, as described above with reference to FIG. 4.

At time t35, in a case where determination is made that the BA is in a state of being able to be returned, the AP returns the BA, which is a signal storing the reception result of the NOMA PPDU, to the STA#1 to STA#N having executed the UL MU communication.

Here, the term “state of being able to return the reception result” represents a state in which the extraction processing of data including the interference cancellation processing and the reception processing up to decoding processing are completed to enable the BA to be generated depending on a decoding result.

At time t36, the BA is received by the STA#1 to STA#N, thereby ending the series of data exchange sequence of the UL MU communication.

### Frame Configuration of ACK Extension

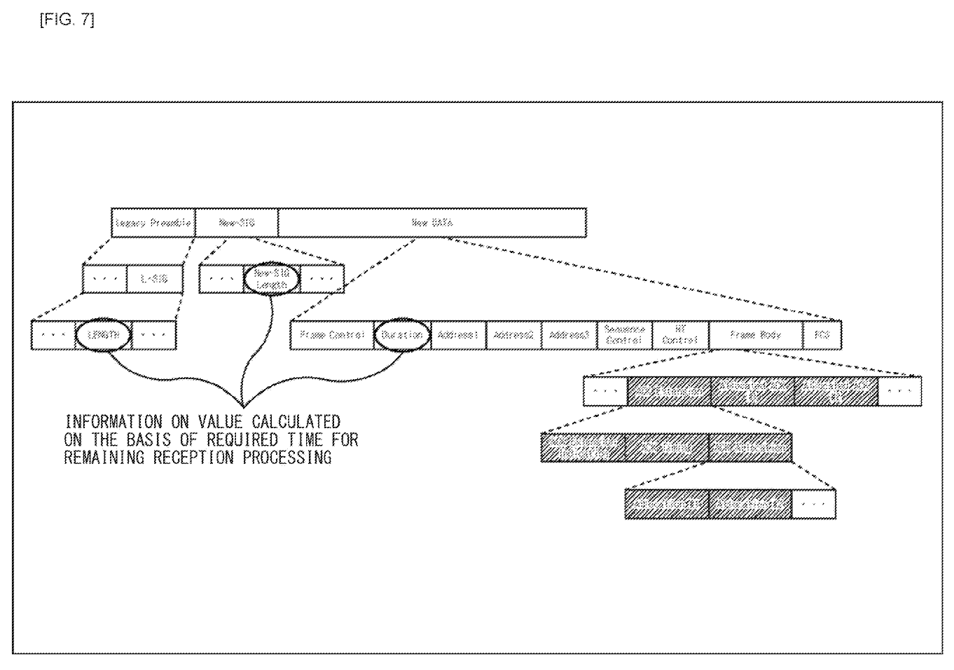

FIG. 7 illustrates an example of a frame configuration of the ACK Extension. It is to be noted that descriptions of the same parts as those of the existing frame configuration are omitted as appropriate. The same also applies to the subsequent descriptions of the frame configurations.

The ACK Extension is configured by Legacy Preamble, New-SIG, and New DATA. The Legacy Preamble and the New-SIG are each a PHY header.

The New DATA includes Frame Control, Duration, a plurality of Addresses, Sequence Control and HT Control, Frame Body, and FCS. The Frame Control, the Duration, the plurality of Addresses, the Sequence Control, and the HT Control are each a MAC header. The Frame Body is a MAC DATA portion.

As illustrated in circled parts in FIG. 7, Length of the Legacy Preamble, New-SIG Length of the New SIG, and the Duration of the MAC header include information on values (occupancy period of the present technology) calculated on the basis of its own processing capability and on the basis of required time for the remaining reception processing. The required time for the remaining reception processing includes the extraction processing time.

As illustrated in the hatched portion in FIG. 7, the Frame Body includes the ACK Extension and a plurality of Allocated ACKs.

The ACK Extension is configured by ACK Extension Indication, ACK Timing, and ACK Allocation.

The ACK Extension Indication is information indicating that the reception result is returned to the subordinate STA within the occupancy period of the present technology, and is also information requesting continuation of waiting for the reception result.

The ACK Timing is information indicating a return timing of the reception result within the occupancy period of the present technology. For example, as described above referring to FIG. 6, in a case where the BA is returned at a plurality of timings including the SIFS interval, the ACK Timing indicates a timing of return within the occupancy period of the present technology.

The ACK Allocation is information indicating in what method the reception result of the STA is returned. For example, in the case of FIG. 5, return methods are illustrated, such as whether the reception result is returned as a portion of the ACK Extension, whether the reception result is returned as the BA alone, and what multiplexing method is used. In addition, in the case of FIG. 6, the ACK Allocation includes a multiplexing method and a return timing of the reception result in combination with the ACK Timing.

The Allocated ACK includes the reception result for the subordinate STA for which cancel processing has been completed at a time point when the ACK Extension is transmitted, in a case where the reception result is returned as a portion of the ACK Extension. The ACK Allocation indicates which reception result of the STA the reception result described in the Allocated ACK corresponds to.

It is to be noted that, in a case where the ACK Extension includes the reception results of a plurality of STAs, the reception results of the plurality of STAs may be subjected to MU multiplexing for transmission.

### 3. Second Embodiment Modification Example of UL MU Communication Using Non-Orthogonal Multiplexing

Next, description is given, as a second embodiment of the present technology, of a modification example in a case of conducting the UL MU communication using the non-orthogonal multiplexing.

### Example of Sequence

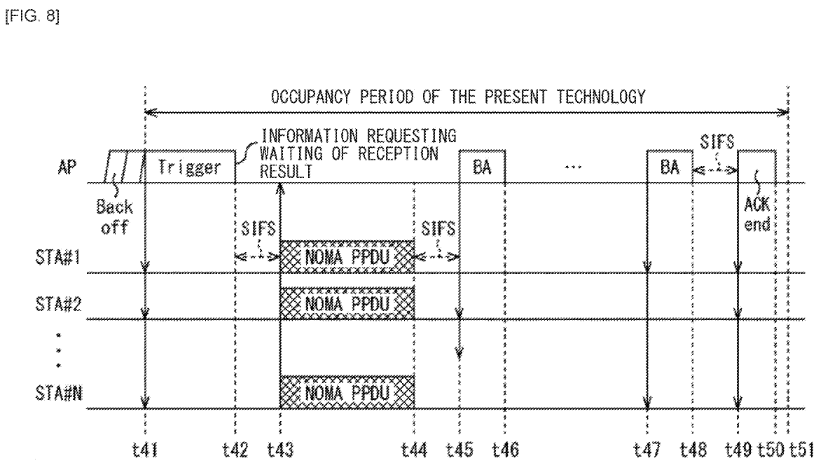

FIG. 8 illustrates an example of a sequence of the second embodiment of the present technology.

After Back off, the AP transmits the Trigger frame requesting the UL MU communication using the non-orthogonal multiplexing to the subordinate STA#1 to STA#N at time t41 at which the transmission opportunity has been acquired. At that time, the AP includes, as information for setting of the occupancy period, an occupancy period (time t41 to time t51) in a signal storing the Trigger frame. The AP calculates the extraction processing time on the basis of its own processing capability, and decides the occupancy period.

The difference between a communication zone set as in the existing technology and the occupancy period of the present technology is as represented by the following expressions (1) and (2).

Existing Technology:

$$\begin{matrix}\text{Time Length of Signal of Trigger+Time Length of Signal of} \\ \text{UL MU Communication} \\ + \text{SIFS} \times 2 \text{+Time Length of ACK} ... \left(1\right)\end{matrix}$$

Present Technology

$$\begin{matrix}\text{Time Length of Signal of Trigger + Time Length of Signal of} \\ \text{UL MU Communication} \\ \text{+ SIFS} \times \text{2 + Time Length of ACK + Anticipated Required Time Until} \\ \text{completion} \\ \text{of Return of Reception Result} ... \left(2\right)\end{matrix}$$

The anticipated required time is calculated from factors of techniques to be used in combination, such as the number of users to be multiplexed, a processing method of interference cancellation, a processing capability of a processor, the number of allowable retransmission, encoding bit number, and the MIMO.

In addition, the Trigger frame to be transmitted at time t41 includes information requesting continuation of waiting for the reception result of the UL MU communication.

The STA#1 to STA#N having been requested to perform the UL MU communication transmit the NOMA PPDU in accordance with a parameter included in the Trigger frame at time t43 at which the SIFS interval has elapsed from time t42 at which the reception of the Trigger was completed.

At time t44 at which the end of the NOMA PPDU has been received and thereafter, the STA#1 to STA#N wait for reception of the BA on the basis of occupancy time included in the Trigger frame and information requesting continuation of waiting for the reception result.

At time t45 at which the SIFS interval has elapsed from time t44, the AP returns the BA, which is the signal storing the reception result of the NOMA PPDU, to STA#2 and another STA. The AP returns the BA from the STA from which the data was able to be extracted by the interference cancellation processing. At this time, the AP may divide the BA for the STA into a plurality of BAs for returning.

At time t49 at which the SIFS interval has elapsed from time t48, which is time after transmission of the end of the BA returned last, the AP transmits ACK end, which is a signal for ending the occupancy period, in a case where the return of BA is completed in a shorter period of time than the occupancy time included in the Trigger frame. Examples in which the return of the BA ends in a shorter period of time than the occupancy time included in the Trigger frame include a case in which the AP is able to correctly performs decoding in the smaller number of times than a predetermined number of times of repetition in the cancel processing.

When the end of the ACK end is received by the STA#1 to STA#N at time t50, or when the occupancy period set by the Trigger frame ends at time t51, the sequence of the UL MU communication ends.

It is to be noted that, in the Trigger frame in FIG. 8, the occupancy period of the present technology is included in Length of the PHY header of the ACK Extension, the New-SIG Length, and the Duration region of the MAC header, similarly to the frame of the ACK Extension in FIG. 7.

### Frame Configuration of A Trigger Frame

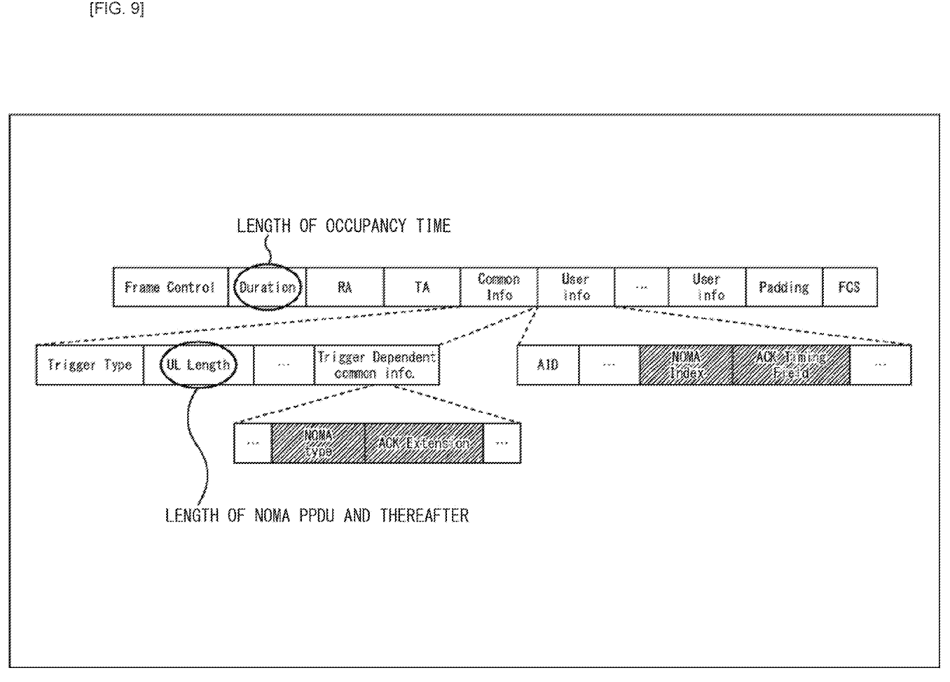

FIG. 9 illustrates an example of a frame configuration of the Trigger frame.

FIG. 9 illustrates the Frame Control and thereafter of the MAC header of the Trigger frame.

In the Frame Control and thereafter, the Trigger frame is configured by the Frame Control, the Duration, RA, TA, Common Info, a plurality of pieces of User info, Padding, and the FCS.

The Duration includes information for setting of a length of the occupancy period, as described above.

The Common Info and the User Info are regions including information common to STAs requested to perform the UL MU communication in the Trigger frame and information that differs for each STA, respectively.

UL Length of the Common Info includes, as a length of the NOMA PPDU and thereafter, for example, “a time length of a signal of the NOMA PPDU + anticipated required time until completion of return of the reception result”.

The ACK Extension of the Common Info and the ACK timing of the User info include the same information as those of the ACK Extension and the ACK timing described above referring to FIG. 7.

NOMA type of the Common Info includes information concerning the non-orthogonal axis to be used in the UL MU communication. NOMA index of the User info indicates a non-orthogonal axis element allocated to each STA.

### Modification Example of Sequence

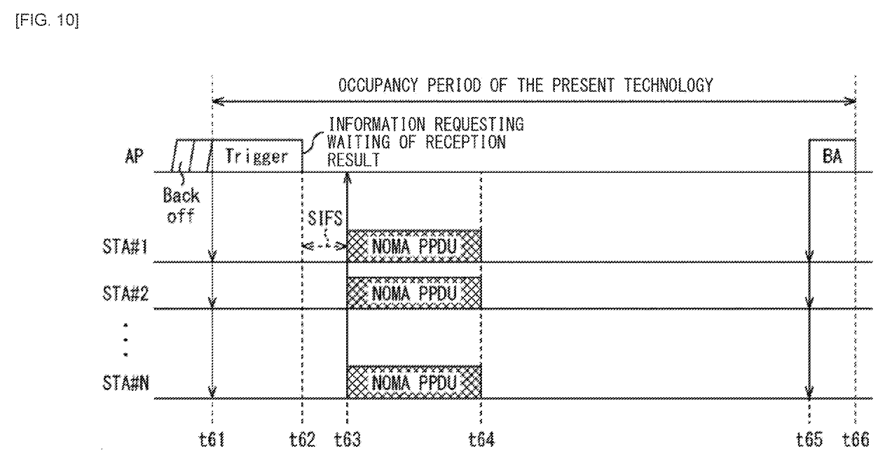

FIG. 10 illustrates a modification example of the sequence of the second embodiment of the present technology.

Pieces of processing of time t61 to time t64 in FIG. 10 are similar to the pieces of processing of time t41 to time t44 in FIG. 8, and thus descriptions thereof are omitted.

In FIG. 10, the AP returns the BA, which is a signal storing the reception result of the NOMA PPDU, toward the STA#1 to STA#N all at once at the end of the occupancy period.

At time t64 at which the end of the NOMA PPDU has been received and thereafter, the STA#1 to STA#N wait for reception of the BA on the basis of the occupancy time included in the Trigger frame and information requesting continuation of waiting for the reception result. The AP returns the BA at time t65 prior to time t66 at the end of the occupancy period included in the Trigger frame.

At time t66, the end of the BA is received by the STA#1 to STA#N, thereby ending the UL MU communication sequence.

### Another Example of Sequence

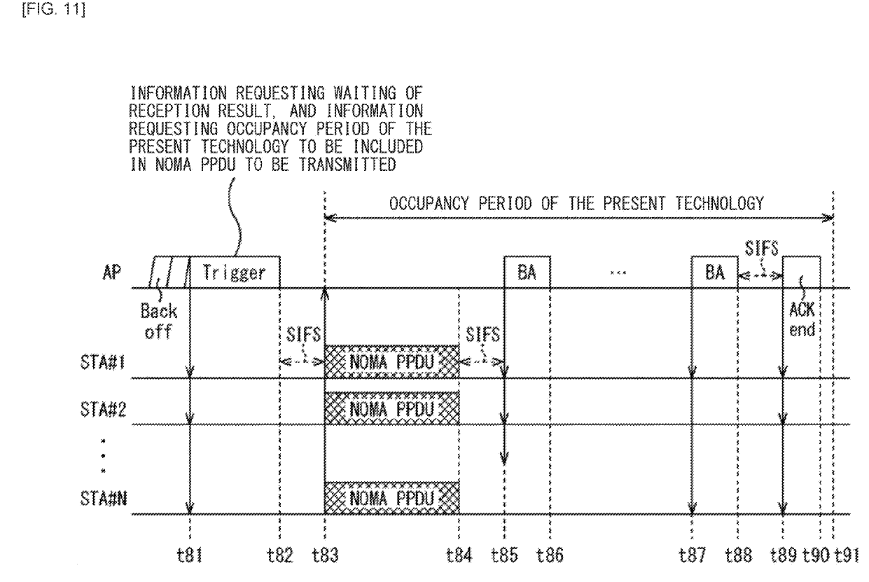

FIG. 11 illustrates another example of the sequence of the second embodiment of the present technology.

FIG. 11 illustrates a sequence in a case where the occupancy period of the present technology is included in the NOMA PPDU, instead of the Trigger frame.

After Back off, the AP transmits the Trigger frame requesting the UL MU communication using the non-orthogonal multiplexing to the subordinate STA#1 to STA#N at time t81 at which the transmission opportunity has been acquired. At this time, the AP decides the occupancy period (time t83 to time t91) to be described in the NOMA PPDU. Similarly to the case of FIG. 8, the AP calculate extraction processing time on the basis of its own processing capability, and decides the occupancy period.

It is to be noted that the occupancy period in the case of FIG. 11 is time obtained by subtracting SIFS × 1 from the expression (2).

Further, at this time, the Trigger frame includes information requesting the occupancy period of the present technology to be included in the NOMA PPDU to be transmitted, in addition to the information requesting the reception result to be waited.

The STA#1 to STA#N having been requested to perform the UL MU communication transmit the NOMA PPDU in accordance with a parameter described in the Trigger frame at time t83 after the elapse of SIFS from time t82 at which the Trigger was received.

In the NOMA PPDU in FIG. 11, the occupancy period of the present technology is included in the Length of the PHY header of the ACK Extension, the New-SIG Length, and the Duration region of the MAC header, similarly to the frame of the ACK Extension in FIG. 7.

It is to be noted that, pieces of processing at time t84 to time t91 in FIG. 11 are similar to the pieces of processing of time 44 to time t51 in FIG. 8, and thus descriptions thereof are omitted.

As described above, causing the occupancy period of the present technology to be included in the NOMA PPDU to be transmitted allows even a terminal existing at a position unable to receive the Trigger frame of the AP to read information on the occupancy period of the present technology described in the signal (NOMA PPPDU) transmitted by the STA, thus making it possible to set a transmission waiting period of an appropriate length.

This consequently makes it possible to prevent the above-mentioned terminal from interrupting in the middle of a series of data exchange sequence in the UL MU communication.

### Modification of Example of Sequence

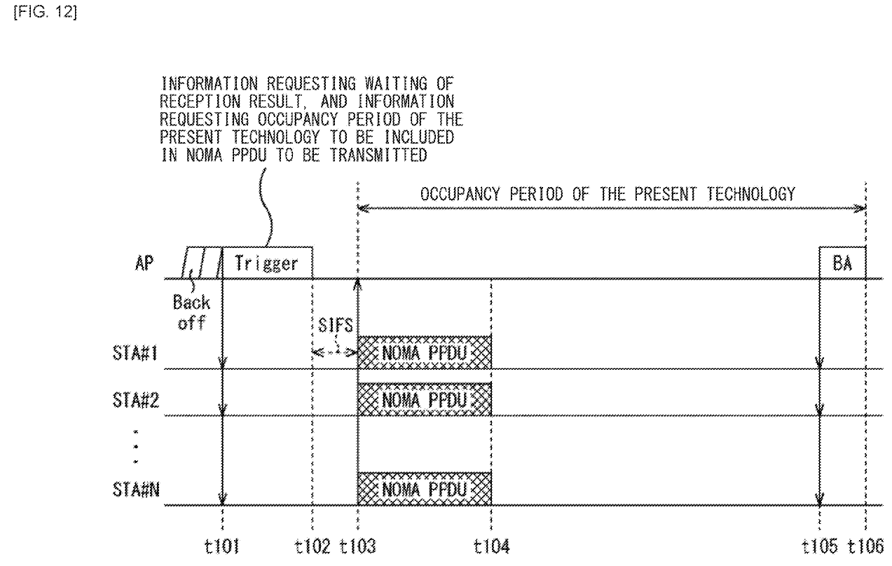

FIG. 12 illustrates a modification example of the sequence of the second embodiment of the present technology.

Similarly to the examples of FIG. 11, FIG. 12 illustrates a sequence in a case where the occupancy period of the present technology is described in the NOMA PPDU instead of the Trigger frame.

After Back off, the AP transmits the Trigger frame requesting the UL MU communication using multiplexing on the non-orthogonal axis to the subordinate STA#1 to STA#N at time t101 at which the transmission opportunity has been acquired. AT that time, the AP decides the occupancy period (time t103 to time t106) of the present technology described in the NOMA PPDU.

At this time, the Trigger frame includes information requesting the occupancy period of the present technology to be included in the NOMA PPDU to be transmitted, in addition to the information requesting the reception result to be waited.

The STA#1 to STA#N having been requested to perform the UL MU communication transmit the NOMA PPDU in accordance with a parameter included in the Trigger frame at time t103 after an elapse of the SIFS from time t102 at which the reception of the Trigger was completed.

It is to be noted that, pieces of processing at time t104 to time t106 in FIG. 12 are similar to the pieces of processing of time 64 to time t66 in FIG. 10, and thus descriptions thereof are omitted.

### 4. Third Embodiment DL MU Communication Using Non-Orthogonal Multiplexing

First, description is given, as a third embodiment of the present technology, of the DL MU communication using the non-orthogonal multiplexing.

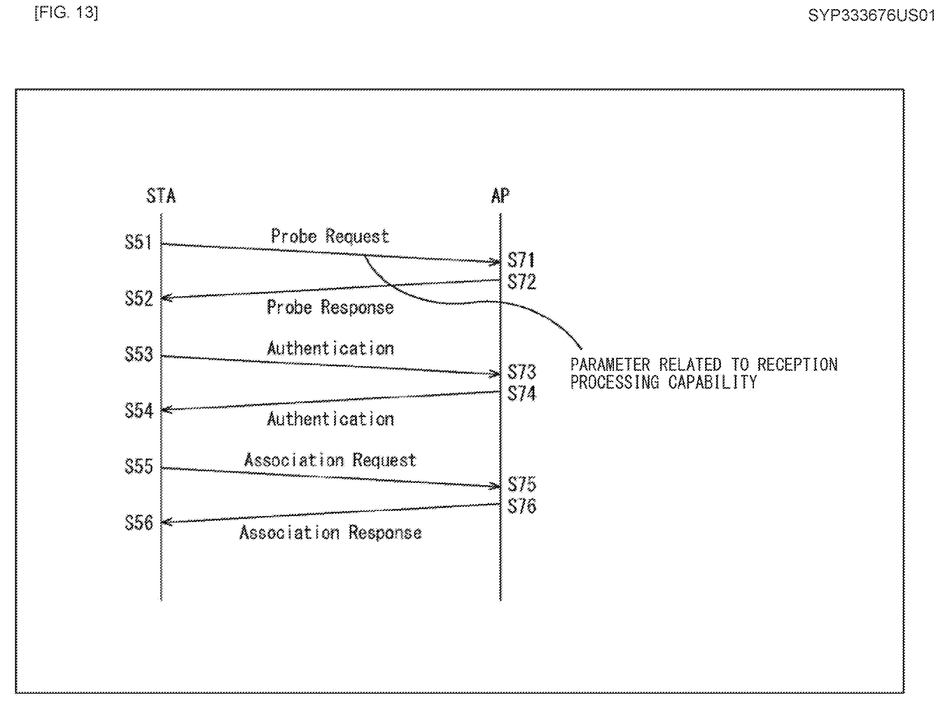

In the wireless communication system in FIG. 1, in a case of performing the DL MU communication using the non-orthogonal multiplexing, first, the AP needs to know a reception processing capability of the STA. Therefore, as illustrated in FIG. 13, when the STA is coupled to the AP, the STA and the AP exchange parameters related to the reception processing capability as a portion of the Capability information.

### Example of Signaling

FIG. 13 illustrates an example of signaling of the third embodiment of the present technology.

In step S51, the STA transmits Probe Request. At this time, the Probe Request includes a parameter related to the receiving processing capability of the STA as a portion of the Capability information of the STA.

In step S71, the AP receives the Probe Request transmitted from the STA. In step S72, the AP transmits Probe Response which is a response to the Probe Request.

In step S52, the STA receive the Probe Response transmitted from the AP. In step S53, the STA transmits, as Authentication, an authentication packet to the AP.

In step S73, the AP receives the authentication packet transmitted from the STA. In step S74, the AP transmits, as the Authentication, the authentication packet to the STA.

In step S54, the STA receives the authentication packet transmitted from the AP. These pieces of processing complete mutual authentication between the STA and the AP.

In step S55, the STA transmits Association Request.

In step S75, the AP receives the Association Request transmitted from the STA. In step S76, the AP transmits Association Response which is a response to the Association Request.

In step S56, the STA receive the Association Response.

The pieces of processing described above allow the STA to be coupled to the AP.

### Frame Configuration of Capability Information

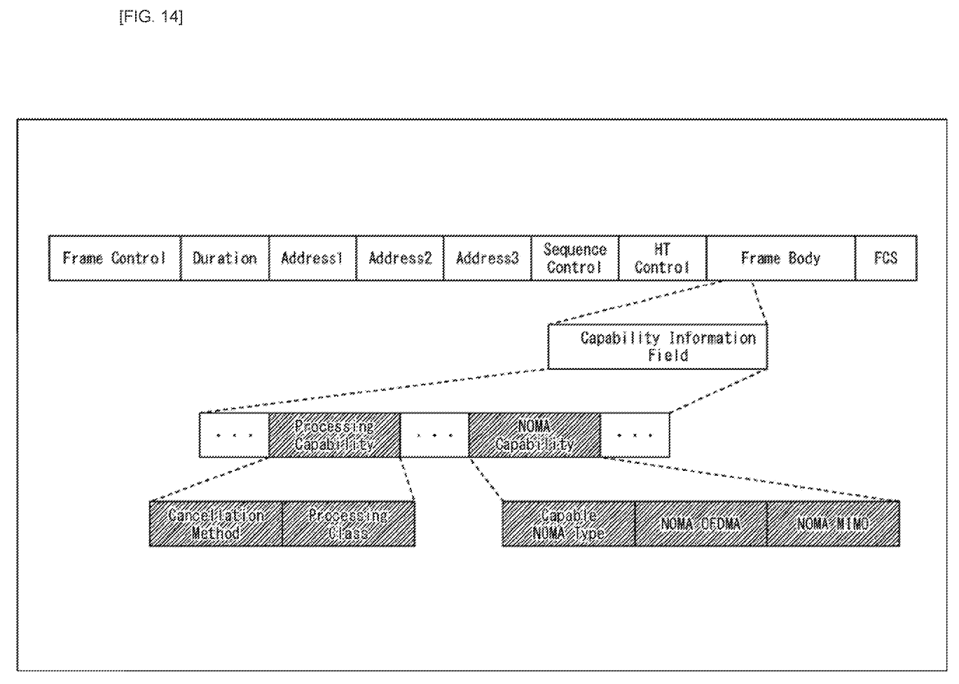

FIG. 14 illustrates an example of a frame configuration of the Capability information.

FIG. 14 illustrates the Frame Control and thereafter of the MAC header of the Capability information.

The Capability information is configured by the Frame Control, the Duration, Address × 3, the Sequence Control, the HT Control, the Frame Body, and the FCS, in the Frame Control and thereafter.

The Capability information field within the Frame Body includes Processing Capability and NOMA Capability.

The Processing Capability is configured by, for example, Cancellation Method and Processing Class. The Cancellation Method includes, for example, information indicating a method of usable interference cancellation processing. The Processing Class includes information indicating a processing capability of a processor. The processing capability of the processor may be represented, for example, by either a classified parameter or a specific numerical value.

The NOMA Capability is configured by Capable NOMA Type, NOMA OFDMA, and NOMA MIMO. The Capable NOMA Type includes information indicating a multiplexing scheme using a corresponding non-orthogonal axis. The NOMA OFDMA includes information indicating “whether a combination of the non-orthogonal multiplexing and the OFDMA is usable”. The NOMA MIMO includes information indicating “whether a combination of the non-orthogonal multiplexing and the MIMO is usable”.

### Example of Sequence

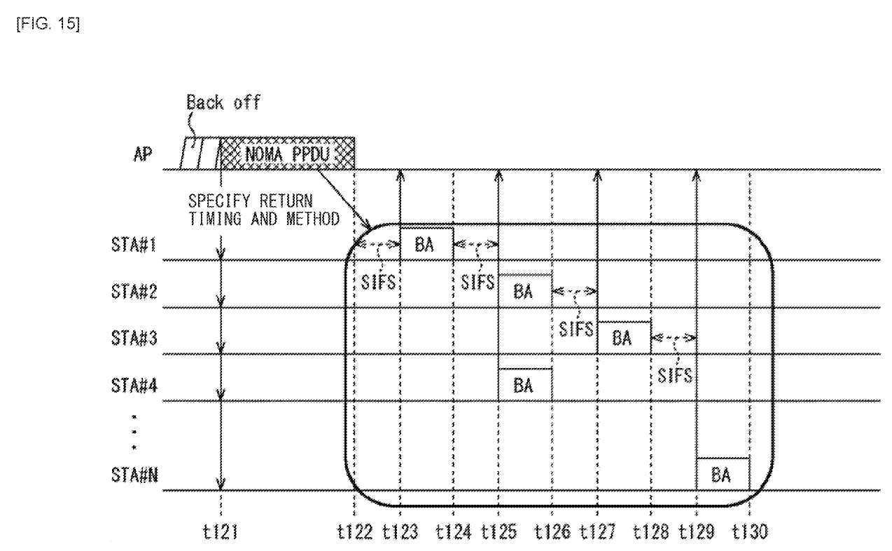

FIG. 15 illustrates an example of a sequence of the third embodiment of the present technology.

FIG. 15 illustrates a sequence in which the AP conducts the DL MU communication using the plurality of STA#1 to STA#N and the non-orthogonal multiplexing.

After Back off, the AP transmits the NOMA PPDU, which is a signal using the non-orthogonal multiplexing, at time t121 at which the transmission opportunity has been acquired. At that time, the AP decides a return timing and a return method of the BA on the basis of the extraction processing time in accordance with the reception processing capability of the STA. The same also applies to cases of other subsequent sequences as for a method for deciding the return timing and the return method of the BA.

The NOMA PPDU includes information specifying, to the STA, the return timing of the BA decided in accordance with the reception processing capability of the STA as well as the return method indicating which STA returns the ACK at which timing. Specifying the return timing of the BA allows the period from the transmission of the NOMA PPDU (time t121) to the completion of the transmission of the BA from all the STAs (time t130) to be substantially the occupancy period. That is, the information specifying, to the STA, the return timing and the return method of the BA may be said to be the information for setting of the occupancy period of the present technology.

FIG. 15 illustrates the case where the return timing and the return method of the BA are specified to all the STAs.

The STA#1 returns the BA in accordance with the return timing and the return method included in the NOMA PPDU at time t123 at which the SIFS interval has elapsed from time t122 at which the reception of the NOMA PPDU was completed.

The STA#2 and STA#4 return the BA in accordance with the return timing and the return method included in the NOMA PPDU at time t125 at which the SIFS interval has elapsed from time t124 at which the STA#1 completed the transmission of the BA.

STA#3 returns the BA in accordance with the return timing and the return method included in the NOMA PPDU at time t127 at which the SIFS interval has elapsed from time t126 at which the STA#2 and the STA#4 completed the transmission of the BA.

The STA#N returns the BA in accordance with the return timing and the return method included in the NOMA PPDU at time t129 at which the SIFS interval has elapsed from time t128 at which the STA#3 completed the transmission of the BA.

Thereafter, the STA#N completes the return of the BA at time t130, and the sequence of the DL MU communication ends.

### Frame Configuration of NOMA PPDU

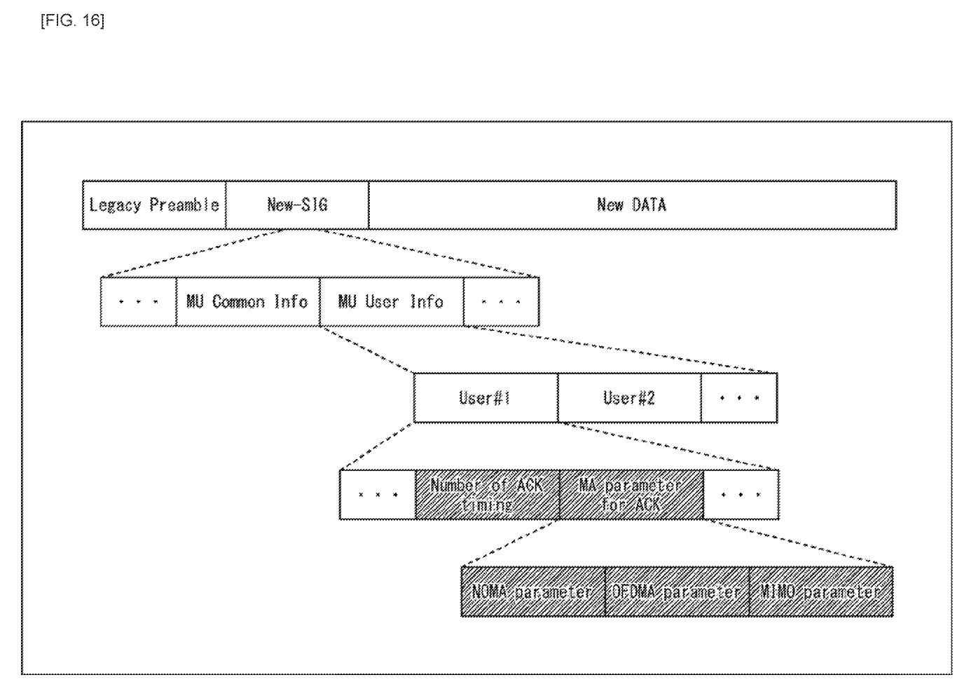

FIG. 16 illustrates an example of a frame configuration of the NOMA PPDU in the case of FIG. 15.

The NOMA PPDU is configured by the Legacy Preamble, the New-SIG, and the New DATA. The New-SIG includes MU Common Info and MU User Info.

The MU Common Info includes information common to all STAs receiving the NOMA PPDU.

The MU User Info includes information unique to each STA receiving the NOMA PPDU. In a case where the return timing is specified for all the STAs, the information concerning the return timing of the BA includes the MU User Info.

The MU User Info includes Number of ACK timing and an MA parameter for ACK for each User (STA). The Number of ACK timing includes information indicating a timing at which the BA is returned.

The MA parameter for ACK includes a parameter to be used by the STA when returning the BA. Specifically, the MA parameter for ACK includes a NOMA parameter, an OFDMA parameter, and a MIMO parameter. The NOMA parameter is a parameter related to the non-orthogonal multiplexing. The OFDMA parameter is a parameter related to the orthogonal multiplexing on a frequency axis using a subchannel by the OFDMA. The MIMO parameter is a parameter related to the spatial multiplexing by the MIMO.

### Another Example of Sequence

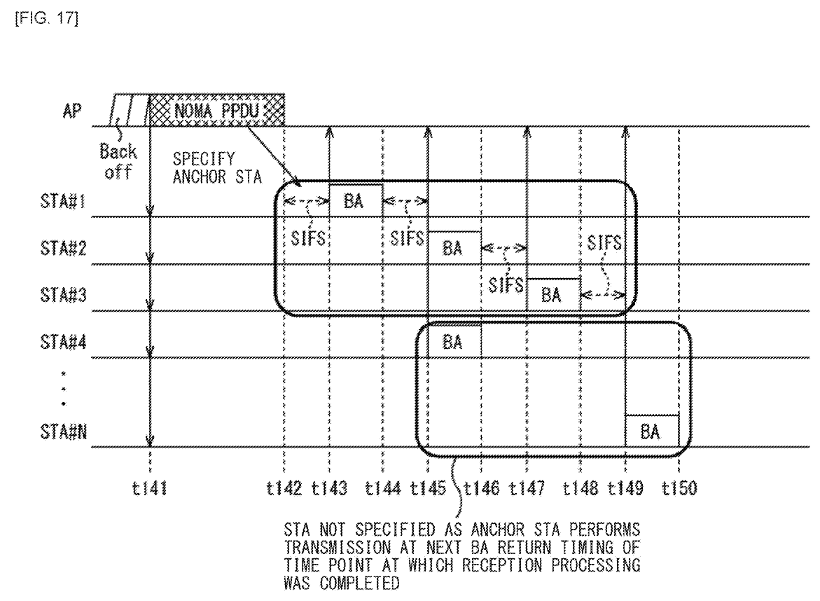

FIG. 17 illustrates another example of the sequence of the third embodiment of the present technology.

FIG. 17 illustrates a sequence in which the DL MU communication is conducted using the non-orthogonal multiplexing in a case of selecting, for each return timing of the BA, an STA (hereinafter, referred to as an anchor STA) specifying the return timing.

After Back off, the AP transmits the NOMA PPDU, which is a signal using the non-orthogonal multiplexing, at time t141 at which the transmission opportunity has been acquired. The NOMA PPDU includes information specifying, to the STA, the return timing and the return method of the BA by the anchor STA, as information for setting of the occupancy period (time t141 to time t150) of the present technology.

FIG. 17 illustrates an example in which the STA#1 to the STA#3 are selected as the anchor STA. In this case, the STA other than the anchor STA transmits the BA in the next return timing of a time period at which the extraction processing including the interference cancellation processing was completed.

The anchor STA is an STA selected to return the BA from the AP at a specific timing including the SIFS interval, and the STA determined to enable the AP to return the BA at a specific timing is selected.

The STA#1, which is the anchor STA, returns the BA in accordance with the return timing and the return method included in the NOMA PPDU at time t143 at which the SIFS interval has elapsed from time t142 at which the reception of the NOMA PPDU was completed.

The STA#2, which is the anchor STA, returns the BA in accordance with the return timing and the return method included in the NOMA PPDU at time t145 at which the SIFS interval has elapsed from time t144 at which the STA#1 completed the transmission of the BA. It is to be noted that the STA#4, which is not the anchor STA, completes the extraction processing by time t144 at which the STA#1 completed the transmission of the BA, and thus returns the BA in accordance with the return timing and the return method included in the NOMA PPDU at time t145 which is the next return timing at which the SIFS interval has elapsed from time t144.

The STA#3, which is the anchor STA, returns the BA in accordance with the return timing and the return method included in the NOMA PPDU at time t147 at which the SIFS interval has elapsed from time t146 at which the STA#2 and the STA#4 completed the transmission of the BA.

The STA#N, which is not the anchor STA, completes the extraction processing by time t148 at which the STA#3 completed the transmission of the BA, and thus returns the BA in accordance with the return timing and the return method included in the NOMA PPDU at time t149 which is the next return timing at which the SIFS interval has elapsed from time t148.

Thereafter, the STA#N completes the transmission of the BA at time t150, and the sequence of the DL MU communication ends.

As described above, the anchor STA returns the BA as the reception result at a designated specific timing, thereby enabling all the STAs having performed the MU communication to return the BA without being interrupted by another wireless apparatus.

The factor for selecting the anchor STA is a factor that causes a reception processing time difference between STAs, and the following factors are considered.
(1) Method of interference cancellation processing to decide a load of processing itself and presence or absence of repetitive processing
(2) Processor processing capability
(3) The number of data-retransmittable times upon transmission of data requiring low delay
(4) MCS (Modulation and Coding Scheme) and encoding bit number obtained from bandwidth/RU (Resource Unit) size
(5) Another technique used together with the non-orthogonal multiplexing such as MIMO
(6) RSSI (Received Signal Strength Indicator) to determine whether decoding is possible by processing with low noise power or with less processing times
(7) Power distribution for each user in which an SIR (Signal to Interference power Ratio) difference occurs among STAs

For example, in a case where there is no selectable anchor STA at a specific timing because of all the STAs being unresponsive, the AP may instead throw a dummy signal or the like at a delivery timing of the BA to prevent interruption by another wireless communication apparatus.

In addition, one STA may be selected as the anchor STA of a plurality of timings. Each STA returns the BA subjected to the non-orthogonal multiplexing at a predetermined timing. At this occasion, it may be possible to use, as the non-orthogonal axis element, the one allocated in advance to itself, or the one newly specified by the NOMA PPDU.

### Another Frame Configuration of NOMA PPDU

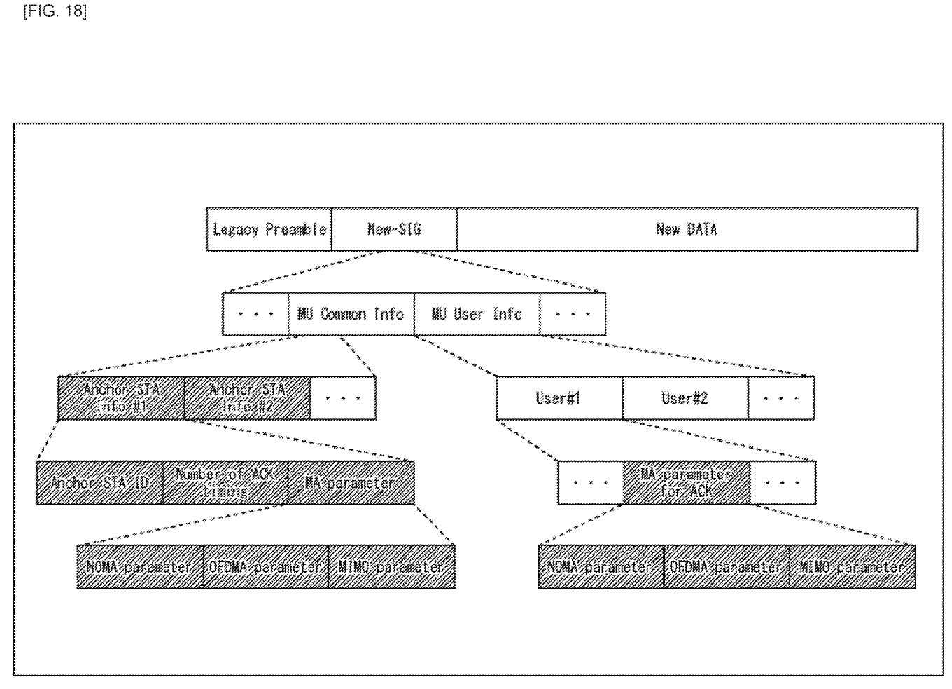

FIG. 18 illustrates an example of a frame configuration of the NOMA PPDU in the case of FIG. 17.

The NOMA PPDU is configured by the Legacy Preamble, the New-SIG, and the New DATA. The New-SIG includes the MU Common Info and the MU User Info.

The MU Common Info includes information common to all STAs receiving the NOMA PPDU. Information concerning the anchor STA (Anchor STA Info) is included in the MU Common Info for each anchor STA (Anchor STA).

The information concerning the anchor STA (Anchor STA Info) includes Anchor STA ID, the Number of ACK timing, and the MA parameter. The anchor STA ID includes information concerning an ID of the STA allocated to the anchor STA. The Number of ACK timing includes information indicating a timing at which the anchor STA returns the BA. It is to be noted that the order of the anchor STA Info may serve as the Number of ACK timing.

The MA parameter is a parameter related to multiplexing to be used in a case where the anchor STA returns the BA. It is to be noted that the MA parameter in FIG. 16 may serve as the MA parameter for ACK.

Information at the time when the STA which is not the anchor STA returns the BA is included in the MU User Info. The MA parameter for ACK of the MU User Info includes each parameter related to the multiplexing, similarly to the case of FIG. 16.

### 5. Fourth Embodiment Modification Example of DL MU Communication Using Non-Orthogonal Multiplexing

First, description is given, as a fourth embodiment of the present disclosure, of a modification example of the case of conducting the DL MU communication using the non-orthogonal multiplexing.

### Example of Sequence

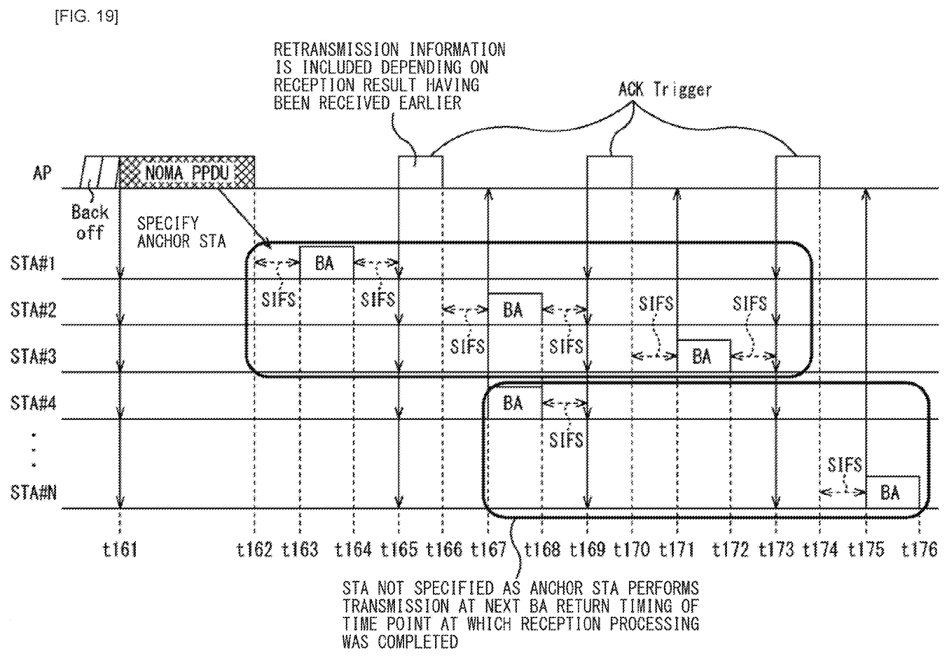

FIG. 19 illustrates an example of a sequence of the fourth embodiment of the present technology.

In the third embodiment described above, the BA is returned as a response to each SIFS interval of the BA by the plurality of STAs; however, in the fourth embodiment, the BA is returned as a response to a signal (ACK Trigger) transmitted by the AP.

After Back off, the AP transmits the NOMA PPDU, which is a signal using the non-orthogonal multiplexing, at time t161 at which the transmission opportunity has been acquired. The NOMA PPDU includes information specifying, to the STA, the return timing and the return method of the BA by the anchor STA, as information for setting of the occupancy period (time t161 to time t176) of the present technology.

FIG. 19 illustrates an example in which the STA#1 to STA#3 are selected as the anchor STA, similarly to the case of FIG. 17. In this case, the STA other than the anchor STA returns the BA in the next return timing of a time point at which the extraction processing including the interference cancellation processing was completed.

The STA#1, which is the anchor STA, returns the BA in accordance with the return timing and the return method included in the NOMA PPDU at time t163 at which the SIFS interval has elapsed from time t162 at which the reception of the NOMA PPDU was completed.

The AP transmits the ACK Trigger at time t165 at which the SIFS interval has elapsed from time t164 at which the reception of the BA was completed. Information on the next anchor STA may be added to the ACK Trigger. In addition, the AP may retransmit data using the ACK Trigger in accordance with the BA received earlier.

The STA#2, which is the anchor STA, returns the BA in accordance with the return timing and the return method included in the NOMA PPDU or the previous ACK Trigger at time t167 at which the SIFS interval has elapsed from time 1166 at which the reception of the ACK Trigger was completed. It is to be noted that the STA#4, which is not the anchor STA, completes the extraction processing by time t166 at which the STA#1 completed the transmission of the BA, and thus returns the BA in accordance with the return timing and the return method included in the NOMA PPDU or the previous ACK Trigger at time t167 which is the next return timing at which the SIFS interval has elapsed from time t166.

The AP transmits the ACK Trigger at time t169 at which the SIFS interval has elapsed from time t168 at which the reception of the BA was completed.

The STA#3, which is the anchor STA, returns the BA in accordance with the return timing and the return method included in the NOMA PPDU or the previous ACK Trigger at time t171 at which the SIF interval has elapsed from time t170 at which the reception of the ACK Trigger was completed.

The AP transmits the ACK Trigger at time t173 at which the SIFS interval has elapsed from time t172 at which the reception of the BA was completed.

The STA#N, which is not the anchor STA, completes the reception processing by time t174 at which the reception of the ACK Trigger was completed, and thus returns the BA in accordance with the return timing and the return method included in the NOMA PPDU or the previous ACK Trigger at time 1175 which is the next return timing at which the SIFS interval has elapsed from time t174.

Thereafter, the STA#N completes the return of the BA at time t176, and the sequence of the DL MU communication ends.

As described above, using the ACK Trigger makes it possible to suppress, for example, loss of a timing of return of the BA by a terminal itself, which is located at a position enabling reception of a signal from the AP and being away from the anchor STA for which transmission is made at a timing one step before, due to being unaware of the timing of the transmission of the BA from the anchor STA.

### Frame Configuration of ACK Trigger

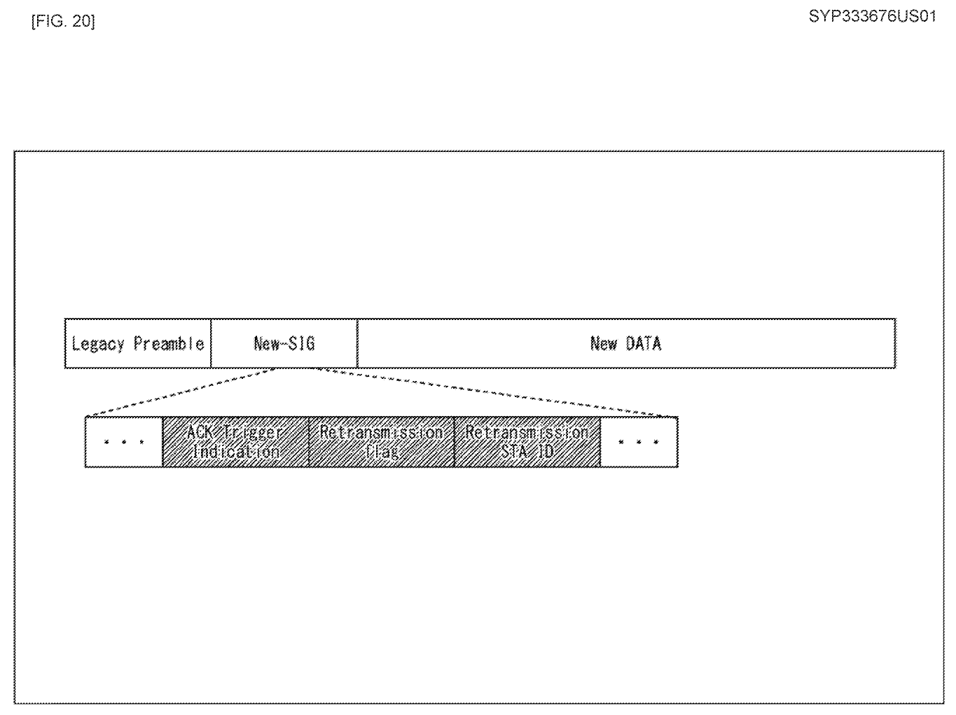

FIG. 20 illustrates an example of a frame configuration of the ACK Trigger.

FIG. 20 illustrates an example of a frame configuration of the ACK Trigger in a case where data is retransmitted in a region managed by a physical layer. In this case, all pieces of information are included in the New-SIG of the PHY header.

The ACK Trigger is configured by the Legacy Preamble, the New-SIG, and the New DATA. The New-SIG includes the ACK Trigger Indication, a Retransmission flag and Retransmission STA ID.

The ACK Trigger Indication includes information indicating that the packet is the ACK Trigger. The Retransmission flag includes information indicating that there is data to be retransmitted. The Retransmission STA ID includes information indicating a destination of the retransmission data.

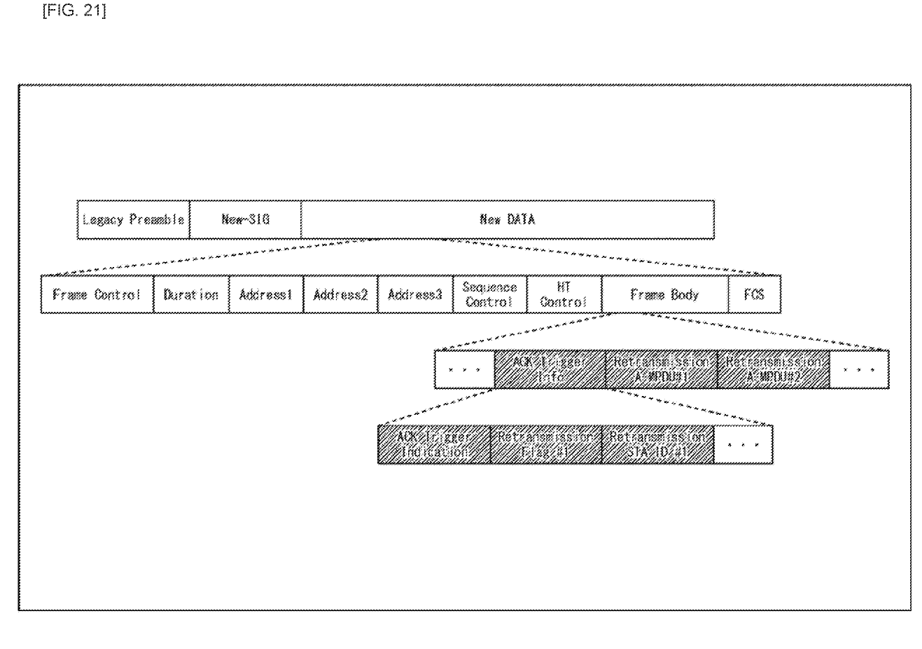

It is to be noted that, in the case of FIG. 20, as for the data to be retransmitted, data similar to the data transmitted to the STA indicated by the Retransmission STA ID may be transmitted as the NOMA PPDU, similarly to FIG. 21 mentioned later. In addition, when being transmitted as the NOMA PPDU, a punctured (bit-eliminated) encoded bit-series may be transmitted.

FIG. 21 illustrates another example of the frame configuration of the ACK Trigger.

FIG. 21 illustrates an example of the frame configuration of the ACK Trigger in a case where data is retransmitted in a region managed by a MAC layer. In this case, all pieces of information are included in the Frame Body which is a MAC DATA portion of the MAC layer.

The ACK Trigger is configured by the Legacy Preamble, the New-SIG, and the New DATA.

In a case of being stored in the Frame Body, retransmission data of the plurality of STAs may be included therein, and thus the ACK Trigger Info of the Frame Body of the New DATA includes one ACK Trigger Indication as well as the Retransmission flag and the Retransmission STA ID for each STA.

A-MPDU to be retransmitted is included as Retransmission A-MPDU behind the ACK Trigger Info.

### 6. Others

### Effects

As described above, in the present technology, a signal including information for setting of the occupancy period of the wireless transmission path is transmitted on the basis of the extraction processing time.

Therefore, it is possible to implement a return timing of the reception result depending on interference cancellation processing time. This enables an increase in the number of multiplexing on the non-orthogonal axis.

In the present technology, it is possible to implement the return timing of the reception result depending on the interference cancellation processing time using a unit of the SIFS interval.

This suppresses interruption by another wireless communication apparatus.

In the present technology, retransmission data is included in a signal notifying of the reception result. This allows one to expect an improvement in decoding performance by the retransmission.

### Configuration Example of Computer

The series of processing described above may be executed by hardware or may be executed by software. In a case of executing the series of processing by software, a program included in the software is installed in a computer incorporated into dedicated hardware or in a general-purpose personal computer, etc., from a program recording medium.

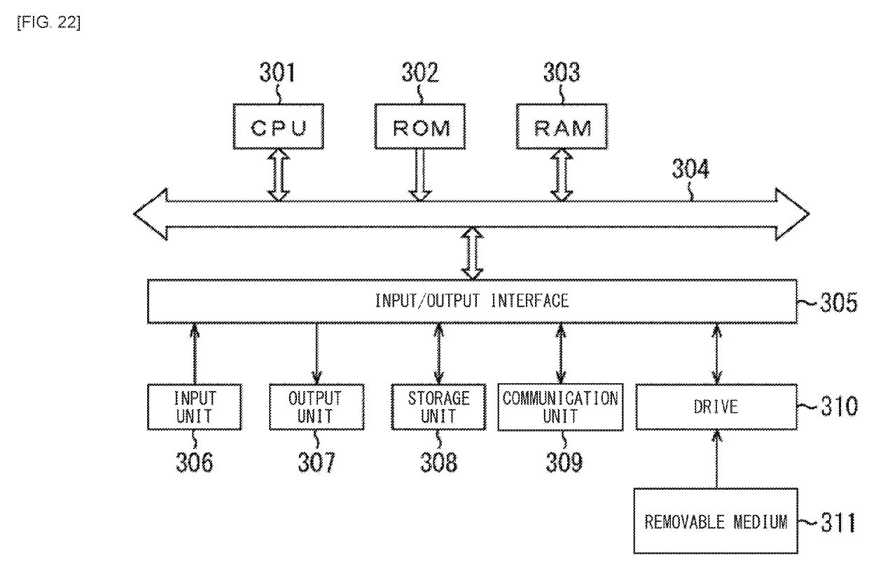

FIG. 22 is a block diagram illustrating a configuration example of hardware of a computer that executes the series of processing described above by a program.

A CPU (Central Processing Unit) 301, a ROM (Read Only Memory) 302, and a RAM (Random Access Memory) 303 are coupled together by a bus 304.

An input/output interface 305 is further coupled to the bus 304. An input unit 306 including a keyboard, a mouse, and the like, and an output unit 307 including a display, a speaker, and the like are coupled to the input/output interface 305. In addition, a storage unit 308 including a hard disk and a non-volatile memory, a communication unit 309 including a network interface, and a drive 310 that drives a removable medium 311 are coupled to the input/output interface 305.

In the computer configured as described above, for example, the CPU 301 loads a program stored in the storage unit 308 into the RAM 303 via the input/output interface 305 and the bus 304 and executes the program to thereby perform the series of processing described above.

For example, the program to be executed by the CPU 301 is recorded in the removable medium 311, or provided via a wired or wireless transmission medium such as a local area network, the Internet, or digital broadcasting, and installed in the storage unit 308.

It is to be noted that the program to be executed by the computer may be a program in which processing is performed in time series in the order described in the present specification, or may be a program in which pieces of processing are performed in parallel or at a necessary timing such as the time when a call is made.

In addition, in the present specification, the term “system” means a set of a plurality of components (devices, modules (parts), etc.), regardless of whether or not all the components exist in the same casing. Accordingly, a plurality of devices housed in separate casings and coupled via a network, and one device in which a plurality of modules is housed in one casing are each a system.

Further, the effects described herein are merely illustrative and are not limitative, and may have other effects.

The embodiment of the present technology is not limited to the above-described embodiment, and may be modified in a wide variety of ways without departing from the gist of the present technology.

For example, the present technology may have a configuration of cloud computing in which one function is shared and processed jointly by a plurality of apparatuses via a network.

In addition, each step described in the above-described flowcharts may be shared and executed by a plurality of devices, in addition to being executed by one apparatus.

Further, in a case where a plurality of pieces of processing are included in one step, the plurality of pieces of processing included in the one step may be shared and executed by a plurality of devices, in addition to being executed by one apparatus.

### Example of Combination of Configurations

The present technology may also have the following configurations.

A wireless communication apparatus including a transmission unit that transmits a signal including information for setting of an occupancy period of a wireless transmission path on a basis of extraction processing time required for processing, which includes interference cancellation processing in communication using non-orthogonal multiplexing, to extract desired data from a received signal.

The wireless communication apparatus according to (1), in which the signal includes information requesting continuation of reception waiting for a reception result of the data during the occupancy period.

The wireless communication apparatus according to (1) or (2), in which the signal includes information concerning a return method of the reception result of the data.

The wireless communication apparatus according to any one of (1) to (3), in which the occupancy period includes a period calculated on a basis of its own processing capability and on the basis of the extraction processing time.

The wireless communication apparatus according to any one of (1) to (4), in which the transmission unit transmits the signal as a response to the received signal.

The wireless communication apparatus according to (5), in which the occupancy period includes a period including a rest of the extraction processing time at a time point at which the signal is generated as the response.

The wireless communication apparatus according to (6), in which the signal includes a reception result of data for which the processing to extract the data was completed.

The wireless communication apparatus according to any one of (1) to (4), in which the transmission unit transmits the signal as a request signal requesting communication from a wireless communication terminal.

The wireless communication apparatus according to (8), in which the occupancy period includes a time length of the signal by which the communication is requested and the extraction processing time.

The wireless communication apparatus according to (9), in which the signal includes information requesting the occupancy period to be included.

The wireless communication apparatus according to (1), in which the occupancy period includes a period calculated on a basis of a processing capability of a subordinate wireless communication terminal that receives the data and on the basis of the extraction processing time.

The wireless communication apparatus according to (11), in which the occupancy period includes a plurality of periods each having a fixed time length specified by a standard, and return time of a reception result of the data.

The wireless communication apparatus according to (12), in which the transmission unit transmits the signal including, as the information for setting of the occupancy period, information concerning a return timing of the reception result of the data, in a manner to be included in the data.

The wireless communication apparatus according to (13), in which the signal includes information concerning the return timing of the reception result of a specific subordinate wireless communication terminal of the subordinate wireless communication terminals.

The wireless communication apparatus according to (12), in which the signal includes a notification signal notifying of a return timing of a reception result of data to be communicated.

The wireless communication apparatus according to (15), in which the signal includes data to be retransmitted.

The wireless communication apparatus according to any one of (11) to (16), further including a reception unit that receives information indicating the processing capability of the subordinate wireless communication terminal.

A wireless communication method including causing a wireless communication apparatus to transmit a signal including information for setting of an occupancy period of a wireless transmission path on a basis of extraction processing time required for processing, which includes interference cancellation processing in communication using non-orthogonal multiplexing, to extract desired data from a received signal.

A wireless communication apparatus including a communication control unit that transmits, on a basis of information concerning a return timing of a received reception result, the reception result of data extracted from a received signal.

A wireless communication method including causing a wireless communication apparatus to transmit, on a basis of information concerning a return timing of a received reception result, the reception result of data extracted from a received signal.

### REFERENCE NUMERALS LIST

11 wireless communication apparatus
12 wireless communication terminal
31 control unit
32 power source unit
31, 33 communication unit
51 data processing section
52 wireless control section
53 modulation/demodulation section
54 signal processing section
55 channel estimation section
56, 56-1 to 56-N wireless interface section
57, 57-1 to 57-N amplifier section
58-1 to 58-N antenna

1. A wireless communication apparatus comprising a transmission unit that transmits a signal including information for setting of an occupancy period of a wireless transmission path on a basis of extraction processing time required for processing, which includes interference cancellation processing in communication using non-orthogonal multiplexing, to extract desired data from a received signal.

2. The wireless communication apparatus according to claim 1, wherein the signal includes information requesting continuation of reception waiting for a reception result of the data during the occupancy period.

3. The wireless communication apparatus according to claim 1, wherein the signal includes information concerning a return method of a reception result of the data.

4. The wireless communication apparatus according to claim 1, wherein the occupancy period comprises a period calculated on a basis of its own processing capability and on the basis of the extraction processing time.

5. The wireless communication apparatus according to claim 4, wherein the transmission unit transmits the signal as a response to the received signal.

6. The wireless communication apparatus according to claim 5, wherein the occupancy period comprises a period including a rest of the extraction processing time at a time point at which the signal is generated as the response.

7. The wireless communication apparatus according to claim 6, wherein the signal includes a reception result of data for which the processing to extract the data was completed.

8. The wireless communication apparatus according to claim 4, wherein the transmission unit transmits the signal as a request signal requesting communication from a wireless communication terminal.

9. The wireless communication apparatus according to claim 8, wherein the occupancy period includes a time length of the signal by which the communication is requested and the extraction processing time.

10. The wireless communication apparatus according to claim 9, wherein the signal includes information requesting the occupancy period to be included.

11. The wireless communication apparatus according to claim 1, wherein the occupancy period comprises a period calculated on a basis of a processing capability of a subordinate wireless communication terminal that receives the data and on the basis of the extraction processing time.

12. The wireless communication apparatus according to claim 11, wherein the occupancy period includes a plurality of periods each having a fixed time length specified by a standard, and return time of a reception result of the data.

13. The wireless communication apparatus according to claim 12, wherein the transmission unit transmits the signal including, as the information for setting of the occupancy period, information concerning a return timing of the reception result of the data, in a manner to be included in the data.

14. The wireless communication apparatus according to claim 13, wherein the signal includes information concerning the return timing of the reception result of a specific subordinate wireless communication terminal of the subordinate wireless communication terminals.

15. The wireless communication apparatus according to claim 12, wherein the signal comprises a notification signal notifying of a return timing of a reception result of data to be communicated.

16. The wireless communication apparatus according to claim 15, wherein the signal includes data to be retransmitted.

17. The wireless communication apparatus according to claim 11, further comprising a reception unit that receives information indicating the processing capability of the subordinate wireless communication terminal.

18. A wireless communication method comprising causing a wireless communication apparatus to transmit a signal including information for setting of an occupancy period of a wireless transmission path on a basis of extraction processing time required for processing, which includes interference cancellation processing in communication using non-orthogonal multiplexing, to extract desired data from a received signal.

19. A wireless communication apparatus comprising a communication control unit that transmits, on a basis of information concerning a return timing of a received reception result, the reception result of data extracted from a received signal.

20. A wireless communication method comprising causing a wireless communication apparatus to transmit, on a basis of information concerning a return timing of a received reception result, the reception result of data extracted from a received signal.
